(19) United States
(12) Patent Application Publication
(10) Pub. No.: US 2013/0164673 A1
(43) Pub. Date: Jun. 27, 2013

(54) METHOD OF MANUFACTURING ELECTROPHOTOGRAPHIC TONER

(71) Applicant: Kao Corporation, Tokyo (JP)

(72) Inventors: Tomohide Yoshida, Wakayama-shi (JP); Eiji Shirai, Wakayama-shi (JP)

(73) Assignee: Kao Corporation, Tokyo (JP)

(21) Appl. No.: 13/728,420

(22) Filed: Dec. 27, 2012

(30) Foreign Application Priority Data
Dec. 27, 2011 (JP) 2011-286935
Dec. 17, 2012 (JP) 2012-274688

(51) Int. Cl. G03G 9/08

(52) U.S. Cl. CPC G03G 9/0804
USPC 430/137.1

(57) ABSTRACT

A method of manufacturing electrophotographic toner containing particles obtained by fusing aggregate particles obtained by aggregating an aqueous dispersion of a polyester resin for toner includes: mixing together at least a polyester resin, an organic solvent, and a neutralizer to obtain a mixture (Step 1); mixing the mixture obtained in the step 1 with at least water to obtain a resin dispersion (Step 2); removing an organic solvent from the resin dispersion obtained in the step 2 to obtain an aqueous dispersion of a polyester resin (Step 3); and mixing the aqueous dispersion obtained in the step 3 with a surfactant optionally (Step 4), in which the aqueous dispersion of the polyester resin for toner is obtained through the steps 1-4, the surfactant is added in a content of 70-100 weight % based on the total amount of the surfactant added in the steps 2 and/or 4.

### FIELD OF THE INVENTION

The present invention relates to a method of manufacturing electrophotographic toner. Specifically, the present invention relates to a method of manufacturing electrophotographic toner used for electrophotography, an electrostatic recording method, an electrostatic printing process, and the like.

### BACKGROUND OF THE INVENTION

Recently, toner with low-temperature fusing properties and storage stability has been desired to increase the speed and the energy-saving potential of a machine. As a method of manufacturing toner, an emulsification-aggregation process capable of reducing the particle size and of functionally separating core shells are the mainstream. As a binder resin, a polyester resin with excellent low-temperature fusing properties is used instead of a styrene acrylic resin.

In manufacturing toner by an emulsification-aggregation process, a resin is first emulsified to generate an aqueous dispersion. The aqueous dispersion is aggregated to obtain particles, and the obtained particles are fused to obtain toner particles. As the emulsification of polyester, phase inversion emulsion capable of obtaining a fine and uniform aqueous dispersion even without high shear been applied is preferably used. To apply phase inversion emulsion to a wide variety of resins, preferably, a resin is mixed with an organic solvent to decrease the viscosity and then subjected to neutralization and phase inversion. However, as a problem on an aqueous dispersion of polyester obtained by phase inversion emulsion, the stability is known to be very low on aggregation, which makes the particle size of toner difficult to be uniformly controlled. Therefore, problems such as the deteriorated storage stability of toner, the decreased gloss of a printed material occurs.

The following technologies are known as the technology improving the stability of an aqueous dispersion. For example, JP-A-2006-84843 describes introducing a sulfonic acid monomer into a polyester backbone chain increases the hydrophilicity and improves the stability. Furthermore, JP-A-6-250439 describes the method of increasing a surfactant or the method of using a surfactant strongly absorbed to an aqueous dispersion as a method of controlling the aggregate stability of a general aqueous dispersion.

### SUMMARY OF THE INVENTION

The present invention relates to the following method of manufacturing electrophotographic toner.

A method of manufacturing electrophotographic toner containing particles obtained by fusing aggregate particles obtained by aggregating an aqueous dispersion of a polyester resin for toner includes:

Step 1: the step of mixing together at least a polyester resin, an organic solvent, and a neutralizer to obtain a mixture;

Step 2: the step of mixing the mixture obtained in the step 1 with at least water to obtain a resin dispersion;

Step 3: the step of removing an organic solvent from the resin dispersion obtained in the step 2 to obtain an aqueous dispersion of a polyester resin; and

Step 4: the step of mixing the aqueous dispersion obtained in the step 3 with a surfactant optionally,

in which the aqueous dispersion of the polyester resin for toner is obtained through the steps 1 to 4, and the surfactant is mixed in a content of 70 to 100 weight % based on the total amount of the surfactant added in the steps 2 and/or 4.

### DETAILED DESCRIPTION OF THE INVENTION

In the method described in JP-A-2006-84843, the storage stability is deteriorated probably because toner easily absorbs moisture, and the gloss of a printed material is significantly decreased probably because the softening temperature of the binder resin is locally increased. Furthermore, in the method described in JP-A-6-250439, the residual surfactant decreases the storage stability and the tribocharging properties after toner is formed. The washing load and the drain load become extensively high when the surfactant is removed. For these reasons, it cannot be said that the method described in JP-A-6-250439 is preferable from the viewpoint of the physical properties of toner and the environmental impact.

The present invention relates to a method of uniformly controlling the particle size distribution of toner to obtain electrophotographic toner, which has excellent heat-resistant storage stability, providing the excellent gloss of a printed material.

The heat-resistant storage stability of toner may basically depend on the softening point and the melting point of the binder resin (polyester resin) forming toner particles but may vary according to the particle size distribution of toner particles even if a similar binder resin is used. When the particle size distribution of toner particles is wide, the temperature transfer rate to the inside of the particles is different according to the size of the particles. Small particles easily dissolve in response to a temperature stimulus, causing toner particles to be fused with each other. On the other hand, regarding the gloss of a printed material, when toner particles has a large particle size, insufficiently fused toner particles remain on the image surface after toner is fused, leading unevenness to be generated at the micro level on the image surface, resulting in the impaired gloss. Therefore, to improve the heat-resistant storage stability of toner and the gloss of a printed material, toner with the particle size distribution being more uniform is desired. In a current toner manufacturing process, fusing aggregate particles obtained by aggregating an aqueous dispersion of a binder resin is the mainstream. However, the causal relationship between the resin particle size of a binder resin in an aqueous dispersion and the particle size distribution of toner particles after aggregation was not well-understood.

The inventors conducted extensive studies and as the result, found that altering the timing to add a surfactant changes the aggregate stability of an aqueous dispersion even when the additive amount is maintained. Furthermore, the inventors found that toner with the particle size distribution being uniform can be obtained by aggregating an aqueous dispersion obtained by adding a predetermined amount of surfactant at a specific time and that as a result, electrophotographic toner is obtained, which has excellent heat-resistant storage stability, providing the excellent gloss of a printed material. The present invention is achieved based on these findings.

The method of manufacturing electrophotographic toner of the present invention containing particles obtained by fusing aggregate particles obtained by aggregating an aqueous dispersion of a polyester resin for toner includes:

Step 1: the step of mixing together at least a polyester resin, an organic solvent, and a neutralizer to obtain a mixture;

Step 2: the step of mixing the mixture obtained in the step 1 with at least water to obtain a resin dispersion;

Step 3: the step of removing an organic solvent from the resin dispersion obtained in the step 2 to obtain an aqueous dispersion of a polyester resin; and

Step 4: the step of mixing the aqueous dispersion obtained in the step 3 with a surfactant optionally,

in which the aqueous dispersion of the polyester resin for toner is obtained through the steps 1 to 4, and the surfactant is added in a content of 70 to 100 weight % based on the total amount of the surfactant added in the steps 2 and/or 4.

All of the details about a mechanism for producing an effect of the present invention have not been clarified, but are presumed as follows.

A surfactant may promote the phenomenon in which a neutralized resin is finely dispersed in a mixture of water and an organic solvent by adding a predetermined amount of surfactant at a specific time. Specifically, when water is added to a neutralized resin dissolving in an organic solvent, phase inversion occurs to finely disperse the resin. Adding a surfactant at this point may promote the resin to be stably dispersed without coalescence or aggregation. However, when a large amount of surfactant is dissolved in an organic solvent, ultramicroscopic particles may be generated by an excessive amount of surfactant at the initial stage of emulsification. These ultramicroscopic particles may decrease the stability during aggregation. On the other hand, the generation of ultramicroscopic particles may be reduced by adding the surfactant after water is mixed with the mixture. This can provide toner with high aggregate stability and narrow particle size distribution, resulting in the improved heat-resistant storage stability of toner and the improved gloss of a printed material.

Furthermore, stable dispersion may need to be maintained in order to obtain more uniform aggregate particles in the subsequent aggregation for manufacturing toner. Adding a specific amount of surfactant may be effectively used in order to avoid the dispersion stability of an aqueous dispersion from being deteriorated even when an organic solvent is removed. Therefore, a surfactant is added after the solvent is removed, so that the surfactant may be present on the surface of polyester particles and so that the aggregate stability may be improved.

The method of producing toner particles of the present invention is to obtain toner particles by aggregating an aqueous dispersion in which a polyester resin is finely dispersed. The uniformity of aggregate particles is determined by the balance of the stability of dispersed polyester microparticles and the aggregability during the addition of aggregating agent. The details about the mechanism for producing an effect of the present invention have not been sufficiently understood. However, presumably, when the timing to add a surfactant and the additive rate meet the conditions specified in the present invention, the suitable emulsification properties are suitable so that excellent toner particles can be generated.

The mechanism for producing an effect of the present invention is not limited to only the above-mentioned putative mechanism.

The components and processes used in the present invention will be explained below.

### (Polyester Resin)

A polyester resin used in the present invention is not limited in particular as long as having physical properties and the like generally used for toner. The polyester resin is obtained by the polycondensation of an alcohol component and a carboxylic acid component. A typical aspect of the polyester resin for toner used in the present invention will be explained below.

The polyester resin for toner used in the present invention may be an amorphous resin, or may be crystalline resin (crystalline polyester). The crystallinity of a resin such as polyester is represented by the ratio of the softening point and the maximum endothermic peak temperature determined with a differential scanning calorimeter (DSC), specifically the crystallinity index defined by “softening point/maximum endothermic peak temperature.” In general, when this crystallinity index more than 1.4, the resin is amorphous. When the crystallinity index is less than 0.6, the resin has low crystallinity and a large amount of amorphous content. In the present invention, the term “crystalline polyester” is referred to as polyester with a crystallinity index of from 0.6 to 1.4, preferably from 0.8 to 1.2, and more preferably from 0.9 to 1.1. The term “amorphous resin” is referred to as a resin with a crystallinity index of more than 1.4 or less than 0.6.

The term “maximum endothermic peak temperature” is referred to as the highest peak temperature of endothermic peaks observed under the conditions of the measurement described in Examples. If the difference between the maximum peak temperature and the softening point is 20° C. or less, the maximum peak temperature is defined as the melting point of a crystalline resin (polyester). If the difference between the maximum peak temperature and the softening point is more than 20° C., the maximum peak temperature is resulted from the glass transition of an amorphous resin.

The crystallinity of the polyester resin used in the present invention can be adjusted according to the type and the proportion of the raw material monomers and according to the processing conditions (e.g., reaction temperature, reaction time, cooling rate) and the like.

### <Alcohol Component>

The alcohol component, which is a raw material monomer of the polyester resin used in the present invention, includes aliphatic diols, aromatic diols, and trivalent or higher polyvalent alcohols. These alcohol components can be used alone or in combination of any two or more.

When the polyester resin used in the present invention is an amorphous resin, the alcohol component that is a raw material monomer of the polyester resin preferably contains, from the viewpoint of amorphizing the resin, the alkylene oxide adduct of bisphenol A represented by the following formula (I):

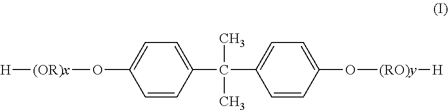

wherein R represents an alkylene group having 2 or 3 carbon atoms, x and y are positive numbers, and a sum of x and y is from 1 to 16, preferably from 1.5 to 5.

The alkylene oxide adduct of the bisphenol A represented by the above-mentioned formula (I) includes polyoxypropylene adducts of 2,2-bis(4-hydroxyphenyl)propane and polyoxyethylene adducts of 2,2-bis(4-hydroxyphenyl)propane.

The alkylene oxide adduct of bisphenol A represented by the above-mentioned formula (I) is contained in a content of preferably from 70 to 100 mol %, more preferably from 80 to 100 mol %, and further preferably from 90 to 100 mol % in the alcohol component, from the viewpoint of amorphizing the polyester resin and from the viewpoint of improving the heat-resistant storage stability of toner and the gloss of a printed material.

When the polyester resin for toner used in the present invention is crystalline polyester, the alcohol component that is a raw material monomer preferably contains an aliphatic diol having 2 to 14, preferably 2 to 6 carbon atoms, from the viewpoint of improving the crystallinity of the polyester.

The aliphatic diol having 2 to 14 carbon atoms includes ethylene glycol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, 1,5-pentanediol, 1,6-hexanediol, neopentylglycol, 2,3-pentanediol, 2,4-pentanediol, 1,7-heptanediol, 1,8-octanediol, 1,9-nonanediol, 1,10-decanediol, and 1,12-dodecanediol.

From the viewpoint of improving the crystallinity of the polyester resin, the aliphatic diol is preferably α,ω-linear alkanediols, more preferably at least one selected from the group consisting of ethylene glycol, 1,3-propanediol, 1,4-pentanediol, 1,5-pentanediol, and 1,6-hexanediol.

When the polyester resin for toner used in the present invention is crystalline polyester, the aliphatic diol having 2 to 14 carbon atoms is contained in a content of preferably from 70 to 100 mol %, more preferably from 80 to 100 mol %, and further preferably from 90 to 100 mol %, in the alcohol component from the viewpoint of improving the crystallinity of the polyester.

For the amorphous resin, an aliphatic diol having 2 to 14 carbon atoms may be used. For the crystalline polyester, an alkylene oxide adduct of bisphenol A can be used.

The polyalcohol component usable as the alcohol component except alkylene oxide adducts of bisphenol A represented by the formula (I) and except aliphatic diols having 2 to 14 carbon atoms includes, for example, a trivalent or higher polyvalent alcohol from the viewpoint of improving the low-temperature fusing properties and the heat-resistant storage stability of toner and the gloss of a printed material. The trivalent or higher polyvalent alcohol specifically includes glycerine, pentaerythritol, and trimethylolpropane. From the viewpoint of the reactivity and the molecular-weight adjustment, glycerine is preferable.

In the case that the alcohol component of the polyester resin contains the trivalent or higher polyvalent alcohol, the content of the trivalent or higher polyvalent alcohol is preferably from 0.1 to 30 mol %, more preferably from 1 to 30 mol %, further preferably from 5 to 30 mol %, in the alcohol component from the viewpoint of improving the low-temperature fusing properties and the heat-resistant storage stability of toner and the gloss of a printed material.

### <Carboxylic Acid Component>

The carboxylic acid component includes aliphatic dicarboxylic acids, aromatic dicarboxylic acids, trivalent or higher valent polycarboxylic acids, and anhydrides and alkyl (1 to 3 carbon atoms) esters of these acids. These carboxylic acid components can be used alone or in combination of any two or more.

Specific examples of the aliphatic dicarboxylic acids include oxalic acid, malonic acid, maleic acid, fumaric acid, citraconic acid, itaconic acid, glutaconic acid, succinic acid, adipic acid, suberic acid, azelaic acid, sebacic acid, 1,10-decane dicarboxylic acid, and dodecanedioic acid. The examples of the aliphatic dicarboxylic acid also include succinic acids substituted with an alkyl group having 1 to 20 carbon atoms or an alkenyl group having 2 to 20 carbon atoms of dodecyl succinic acid, dodecenyl succinic acid, octenylsuccinic acid, or the like. Among these, the aliphatic dicarboxylic acid is preferably fumaric acid, dodecenyl succinic acid, and octenylsuccinic acid, more preferably fumaric acid, from the viewpoint of the heat-resistant storage stability of toner and the gloss of a printed material.

Specific examples of the aromatic dicarboxylic acids include terephthalic acid, phthalic acid, and isophthalic acid. Among these, terephthalic acid is preferable from the viewpoint of the heat-resistant storage stability of toner and the gloss of a printed material.

Specific examples of the trivalent or higher-polyvalent polycarboxylic acids include 1,2,4-benzene tricarboxylic acid (trimellitic acid), 2,5,7-naphthalene tricarboxylic acid, and 1,2,4,5-benzene tetracarboxylic acid (pyromellitic acid). Among these, from the viewpoint of the heat-resistant storage stability of toner and the gloss of a printed material, anhydrous trimellitic acid is preferable.

The content of the trivalent or higher polyvalent carboxylic acid is preferably from 0.1 to 30 mol %, more preferably from 1 to 30 mol %, further preferably from 5 to 30 mol %, in the carboxylic acid component of the polyester resin from the viewpoint of improving the heat-resistant storage stability of toner and the gloss of a printed material.

From the viewpoint of adjusting the molecular weight and the physical properties, the alcohol component may appropriately contain a monovalent alcohol, and the carboxylic acid component may appropriately contain a monovalent carboxylic acid.

### <Mole Ratio of Alcohol Component and Carboxylic Acid Component>

The mole ratio of the alcohol component and the carboxylic acid component (carboxylic acid component/alcohol component) which are raw material monomers for the polycondensation is preferably from 0.50 to 1.50, more preferably from 0.7 to 1.3, further preferably from 0.85 to 1.15, from the viewpoint of the reactivity and from the viewpoint of adjusting the molecular weight and the physical properties.

### <Composite Resin (Modified Polyester)>

From the viewpoint of improving the heat-resistant storage stability of toner and the gloss of a printed material, the polyester resin used in the present invention preferably contains a composite resin (a modified polyester) containing a polyester resin segment (a1) and a vinyl resin segment (a2).

Therefore the polyester resin used in the present invention can be a composite resin generated by addition polymerization in addition to the polycondensation of (i) raw material monomers of the vinyl resin and (ii) a double-reactive monomer capable of reacting with both of the raw materials (i) and the alcohol component.

The raw material monomers of the vinyl resin component includes styrene compounds such as styrene and α-methyl styrene; ethylene-unsaturated monoolefins such as ethylene and propylene; diolefins such as butadiene; halovinyls such as vinyl chloride; vinylesters such as vinyl acetate and vinyl propionate; esters of ethylene monocarboxylic acids such as alkyl (1 to 18 carbon atoms) esters of (meth)acrylic acid and (meth)acrylic acid dimethylaminoethyl; vinylethers such as vinylmethylether; vinylidene halides such as vinylidene chloride; and N-vinyl compounds such as N-vinylpyrrolidone. From the viewpoint of the reactivity, the raw material monomers of the vinyl resin is preferably styrene compounds and alkyl (1 to 18 carbon atoms) esters of (meth)acrylic acid, more preferably styrene, butyl acrylate, 2-ethylhexyl acrylate and methyl methacrylate, further preferably styrene and 2-ethylhexyl acrylate.

Styrene and/or the alkyl ester of (meth)acrylic acid is preferably contained in a content of 50 weight % or more, more preferably from 80 to 100 weight %, in the vinyl resin component.

The amount used of the raw material monomers of the vinyl resin component is a weight ratio of the polyester component and the vinyl resin component (weight of polyester component/weight of vinyl resin component) of preferably from 50/50 to 95/5, more preferably from 65/45 to 90/10, further preferably from 70/30 to 85/15, from the viewpoint of the heat-resistant storage stability of toner and the gloss of a printed material.

The double-reactive monomer capable of reacting with both of the raw material monomers of the vinyl resin and the alcohol component includes, in the molecular, compounds with at least one functional group selected from the group consisting of a hydroxyl group, a carboxyl group, an epoxy group, a primary amino group, and a secondary amino group. Among these, this double-reactive monomer is preferably a compound with a hydroxyl group and/or a carboxyl group, more preferably a compound with a carboxyl group and an ethylene-unsaturated bond, from the viewpoint of the reactivity. Using such a double-reactive monomer can further improve the dispersibility of a resin to be a dispersed phase.

The double-reactive monomer includes acrylic acid, methacrylic acid, maleic acid, and maleic anhydride. From the viewpoint of the reactivity of polycondensation and addition polymerization, acrylic acid and methacrylic acid are more preferable. Fumaric acid is one of the compounds possible to serve as the double-reactive monomer and therefore a preferable compound. However, when used as a carboxylic acid raw material for the polycondensation of the composite resin, fumaric acid is excluded from the double-reactive monomers.

The amount used of the double-reactive monomer is preferably from 2 to 25 mol, more preferably from 3 to 20 mol, further preferably from 5 to 18 mol, furthermore preferably from 6 to 15 mol, based on 100 mol of the alcohol component from the viewpoint of the dispersibility of the vinyl resin component, the heat-resistant storage stability of toner, and the gloss of a printed material. From the same viewpoint, the amount used of the double-reactive monomer is preferably from 2 to 25 mol, more preferably from 3 to 20 mol, further preferably from 5 to 18 mol, and furthermore preferably from 6 to 13 mol, based on 100 mol of the raw material monomers of the vinyl resin component.

### <Physical Properties of Polyester Resin>

The softening point of the polyester resin used in the present invention is preferably from 60 to 160° C., more preferably from 60 to 140° C., further preferably from 65 to 130° C., furthermore preferably from 65 to 120° C., furthermore preferably from 80 to 110° C., from the viewpoint of the low-temperature fusing properties and the heat-resistant storage stability of toner. The glass transition temperature of the polyester resin used in the present invention is preferably from 45 to 85° C., more preferably from 50 to 80° C., from the viewpoint of the low-temperature fusing properties and the heat-resistant storage stability of toner. The glass transition temperature is physical properties specific to an amorphous resin and therefore distinguished from the maximum peak temperature of heat of fusion.

The number-average molecular weight of the polyester resin is preferably from 1,000 to 6,000, more preferably from 2,000 to 5,000, from the viewpoint of the heat-resistant storage stability of toner and the gloss of a printed material. The weight-average molecular weight is preferably from 6,000 to 1,000,000, more preferably from 8,000 to 1,000,000, further preferably from 10,000 to 500,000, from the viewpoint of the heat-resistant storage stability of toner and the gloss of a printed material. The number-average molecular weight and the weight-average molecular weight are determined by measuring tetrahydrofurane solubles.

The acid value of the polyester resin is preferably from 1 to 40 mgKOH/g, more preferably from 2 to 35 mgKOH/g, further preferably from 3 to 30 mgKOH/g, furthermore preferably from 15 to 25 mgKOH/g, from the viewpoint of the stabilized-dispersing resin particles, the sharpened particle size distribution of toner with a small diameter, the heat-resistant storage stability of toner, and the gloss of a printed material.

From the same viewpoint, the hydroxyl value of the polyester resin is preferably from 1 to 70 mgKOH/g, more preferably from 2 to 60 mgKOH/g, further preferably from 3 to 50 mgKOH/g.

The softening point, the glass transition temperature, the number-average molecular weight, the weight-average molecular weight, the acid value, and the hydroxyl value can be easily controlled by adjusting the composition of the raw material monomers, the molecular weight, and the catalytic amount, and the like or by selecting the reaction condition.

### (Method of Producing Polyester Resin)

The polyester resin is obtained by polycondensation of the alcohol component and the carboxylic acid component. The polycondensation is preferably conducted in the presence of an esterification catalyst. From the viewpoint of the reactivity and from the viewpoint of adjusting the molecular weight and the physical properties, the polycondensation is more preferably conducted in the presence of an esterification catalyst and a pyrogallol compound.

### <Esterification Catalyst>

The esterification catalyst preferably used for the above-mentioned polycondensation includes a titanium compound and a tin(II) compound without Sn—C bonds. These compounds may be used alone or in combination of any two or more.

The titanium compound preferably has a Ti—O bond, more preferably an alkoxy group, an alkenyloxy group, or an acyloxy group having 1 to 28 carbon atoms.

The tin(II) compound without Sn—C bonds preferably includes a tin(II) compound with an Sn—O bond, a tin(II) compound with an Sn—X bond (where X represents a halogen atom), and the like. A tin(II) compound with an Sn—O bond is more preferable. Particularly, from the viewpoint of the reactivity and from the viewpoint of adjusting the molecular weight and the physical properties, di(2-ethylhexanoic acid)tin(II) is further preferable.

The amount of the above-mentioned esterification catalyst is preferably from 0.01 to 1 part by weight, more preferably from 0.1 to 0.6 parts by weight, based on 100 parts by weight of the total amount of the carboxylic acid component and the alcohol component, from the viewpoint of the reactivity and from the viewpoint of adjusting the molecular weight and the physical properties.

### <Pyrogallol Compound>

The pyrogallol compound has a benzene ring in which three hydrogen atoms adjacent to each other are substituted with hydroxyl groups respectively, including pyrogallol, gallic acid, gallic acid ester, benzophenone derivatives such as 2,3,4-trihydroxybenzophenone, 2,2′,3,4-tetrahydroxybenzophenone, and catechin derivatives such as epigallocatechin and epigallocatechin gallate. From the viewpoint of the reactivity, gallic acid is preferable.

The amount of the pyrogallol compound in the polycondensation is preferably from 0.001 to 1 part by weight, more preferably from 0.005 to 0.4 parts by weight, further preferably from 0.01 to 0.2 parts by weight, based on 100 parts by weight of the total amount of the carboxylic acid component and the alcohol component subjected to the polycondensation, from the viewpoint of the reactivity. The amount of the pyrogallol compound means the total compounding amount of the pyrogallol compound subjected to the polycondensation.

The weight ratio of the pyrogallol compound and the esterification catalyst (pyrogallol compound/esterification catalyst) is preferably from 0.01 to 0.5, more preferably from 0.02 to 0.3, further preferably from 0.03 to 0.2, from the viewpoint of the reactivity.

The polycondensation of the alcohol component and the carboxylic acid component can be conducted, for example, at a temperature of from 120 to 250° C., preferably from 140 to 240° C., in the presence of the esterification catalyst in an inert gas atmosphere.

For example, all the monomers are preferably added to the reaction system, from the viewpoint of increasing the strength of the resin. Further, it is preferable that a divalent monomer is previously reacted and then a trivalent or higher polyvalent monomer is added and reacted, from the viewpoint of reducing a low-molecular-weight component. Alternatively, the reaction is preferably promoted by reducing the pressure of the reaction system in the second half of the polymerization.

### (Method of Producing Composite Resin)

The composite resin is preferably produced by any one of the following methods (1) to (3). The double-reactive monomer is preferably provided to the reaction system together with the raw material monomers of the vinyl resin component from the viewpoint of reactivity.

(1) The step (A) of the polycondensation with the alcohol component and the carboxylic acid component is conducted, and then the step (B) of addition polymerization with the raw material monomers of the vinyl resin component and the double-reactive monomer is conducted.

After the step (B), the reaction temperature can be increased again, and then, if necessary, the trivalent or higher polyvalent raw material monomer or the like of the polycondensed resin component can be added in the polymerization system as a cross-linker, so as to further promote the polycondensation of the step (A) and the reaction with the double-reactive monomer.

(2) After the step (B) of the addition polymerization with the raw material monomers of the vinyl resin component and the double-reactive monomer is conducted, the step (A) of the polycondensation with the raw material monomers of the polycondensed resin component.

The alcohol component and the carboxylic acid component can be present in the reaction system during the addition polymerization. Then, the esterification catalyst can be added at a temperature suitable for the polycondensation or added in the reaction system under a temperature condition suitable for the polycondensation so as to initiate the polycondensation. In the former case, adding the esterification catalyst at a temperature suitable for the polycondensation can control the molecular weight and the molecular weight distribution.

(3) The step (A) of polycondensation of the alcohol component and the carboxylic acid component is conducted together with the step (B) of addition polymerization with the raw material monomers of the vinyl resin component and a double-reactive monomer.

Preferably, in this method, the steps (A) and (B) are conducted under a reaction temperature condition suitable for the addition polymerization, and then the reaction temperature is increased under a temperature condition suitable for the polycondensation, and then, if necessary, the trivalent or higher polyvalent raw material monomer of the polycondensed resin component is added to the polymerization system as a cross-linker, so as to conduct the polycondensation of the step (A). In this case, under a temperature condition suitable for the polycondensation, a radical polymerization inhibitor can be added to promote only the polycondensation. The double-reactive monomer is involved in the addition polymerization as well as the polycondensation.

Among these, the method (1) is preferable in terms of the high flexibility of the reaction temperature of the polycondensation.

The temperature suitable for the addition polymerization is preferably 120° C. or more and less than 180° C., more preferably 145° C. or more and less than 180° C., further preferably 155° C. or more and less than 170° C. As described below, the temperature suitable for the polycondensation is preferably from 180 to 250° C., more preferably from 180 to 230° C.

The above-mentioned methods (1) to (3) are preferably conducted in the same container.

### (Aqueous Dispersion of Polyester Resin)

The aqueous dispersion of the polyester resin used in the present invention can be prepared by mixing together the polyester resin, an organic solvent, a surfactant, and water, optionally a neutralizer, and then by removing the organic solvent.

### (Organic Solvent)

The organic solvent is preferably from 15.0 to 26.0 MPa¹″², more preferably from 16.0 to 24.0 MPa^{1/2}, and further preferably from 17.0 to 22.0 MPa^{1/2}, represented by a solubility parameter (SP value: POLYMER HANDBOOK THIRD EDITION 1989 by John Wiley & Sons, Inc.) from the viewpoint of improving the dispersibility of the polyester resin.

The specific examples of the organic solvent include alcohol solvents such as ethanol (26.0), isopropanol (23.5) and isobutanol (21.5); ketone solvents such as acetone (20.3), methyl ethyl ketone (19.0), methyl isobutyl ketone (17.2) and diethyl ketone (18.0); ether solvents such as dibutyl ether (16.5), tetrahydrofurane (18.6) and dioxane (20.5); and acetate ester solvents such as ethyl acetate (18.6) and isopropyl acetate (17.4). In parentheses, the SP values are shown. Among these, the organic solvent is preferably ketone solvents and acetate ester solvents, more preferably at least one selected from the group consisting of methyl ethyl ketone, ethyl acetate and isopropyl acetate, from the viewpoint of the particle size distribution and the heat-resistant storage stability of toner and the gloss of a printed material. The organic solvent is further preferably ethyl acetate and/or isopropyl acetate from the viewpoint of the heat-resistant storage stability of toner, furthermore preferably ethyl acetate from the viewpoint of the gloss of a printed material.

### (Neutralizer)

The neutralizer used in the present invention includes hydroxides of alkali metals such as lithium hydroxide, sodium hydroxide and potassium hydroxide; and organic bases such as ammonia, trimethylamine, ethylamine, diethylamine, triethylamine, triethanolamine and tributylamine. Among these, the neutralizer preferably has a pKa of 12 or less, more preferably a pKa of 10 or less, from the viewpoint of the heat-resistant storage stability of toner and the gloss of a printed material. Further, from the same viewpoint, the neutralizer has more preferably a pKa of 8 or more. Particularly, ammonia (pKa=9.3) and triethylamine (pKa=9.8) are preferable. Furthermore, from the viewpoint of the gloss of a printed material, ammonia is preferable.

The degree of neutralization of the polyester resin with the neutralizer is preferably from 20 to 100 mol %, more preferably from 25 to 90 mol %, further preferably from 30 to 80 mol %, furthermore preferably from 30 to 70 mol %, from the viewpoint of the heat-resistant storage stability of toner and the gloss of a printed material. The degree of neutralization (mol %) of a resin can be determined by the following expression:

Degree of neutralization={(weight (g) of neutralizer)/(equivalent amount of neutralizer)}/{((acid value (mgKOH/g) of resin)×(weight (g) of resin))/(56×1000)}×100.

### (Surfactant)

The surfactant includes a nonionic surfactant, an anionic surfactant, and a cationic surfactant. Particularly, the surfactant is preferably a nonionic surfactant and/or an anionic surfactant, more preferably an anionic surfactant, from the viewpoint of the dispersibility of the polyester resin.

The nonionic surfactant includes polyoxyethylene alkyl arylethers or polyoxyethylene alkylethers such as polyoxyethylene nonylphenyl ether, polyoxyethylene oleyl ether, and polyoxyethylene lauryl ether; polyoxyethylene fatty acid esters such as polyethylene glycol monolaurate, polyethylene glycol monostearate, and polyethylene glycol monooleate; and an oxyethylene/oxypropylene block copolymer. Among these, polyoxyethylene alkyl ethers are preferable from the viewpoint of the emulsification stability of a resin.

The anionic surfactant includes alkylbenzenesulfonates such as sodium alkylbenzenesulfonate; alkyl sulfates such as sodium alkylsulfate; and alkyl ether sulfates such as sodium alkyl ether sulfate. Among these, the anionic surfactant is preferably sodium alkylbenzenesulfonate and sodium alkyl ether sulfate, more preferably sodium dodecylbenzenesulfonate, from the viewpoint of the emulsification stability of a resin.

The cationic surfactant includes alkyltrimethylammonium chloride and dialkyldimethylammonium chloride.

In particular, the surfactant is preferably polyoxyethylene alkylethers and/or alkylbenzenesulfonates, more preferably alkylbenzenesulfonates, from the viewpoint of the dispersibility of the polyester resin and the emulsion stability of a resin.

### (Method of Producing Electrophotographic Toner)

The method of manufacturing electrophotographic toner according to the present invention includes the below-mentioned step of obtaining the aqueous dispersion of the polyester resin for toner. The method is not limited, but preferably includes the steps of obtaining aggregate particles by aggregating the aqueous dispersion of the polyester resin and of obtaining coalesced particles (fused particles) by coalescing aggregate particles.

In the present invention, the term “aqueous dispersion” is referred to as a dispersion which may contain a solvent such as an organic solvent but which contains water in a content of preferably 50 weight % or more, more preferably 70 weight % or more, further preferably 90 weight % or more, furthermore preferably 99 weight % or more.

### <Process of Producing Aqueous Dispersion of Polyester Resin>

The aqueous dispersion of the polyester resin used in the present invention is obtained through the following steps 1 to 4.

Step 1: the step of mixing together at least a polyester resin, an organic solvent, and a neutralizer to obtain a mixture

Step 2: the step of mixing the mixture obtained in the step 1 with at least water to obtain a resin dispersion

Step 3: the step of removing an organic solvent from the resin dispersion obtained in the step 2 to obtain an aqueous dispersion of a polyester resin

Step 4: the step of mixing the aqueous dispersion obtained in the step 3 with a surfactant optionally

In the present invention, the surfactant is added in a content of from 70 to 100 weight % based on the total amount of the surfactant added in the steps 2 and/or 4 from the viewpoint of the heat-resistant storage stability of toner and the gloss of a printed material. The surfactant is added in a content of preferably from 80 to 100 weight %, more preferably from 90 to 100 weight %, from the viewpoint of the heat-resistant storage stability of toner and the gloss of a printed material. When the step 4 is conducted, the surfactant is mixed in a content of preferably from 50 to 100 weight %, more preferably from 60 to 100 weight %, further preferably from 70 to 100 weight %, furthermore preferably from 80 to 100 weight %, in the step 4 based on the total amount of the surfactant added in the steps 2 and 4 from the viewpoint of the gloss of a printed material.

The total additive amount of the surfactant is preferably 20 parts by weight or less, more preferably 15 parts by weight or less, further preferably from 0.1 to 10 parts by weight, furthermore preferably from 0.5 to 5 parts by weight, based on 100 parts by weight of the polyester resin from the viewpoint of the heat-resistant storage stability of toner and the gloss of a printed material.

Specifying the timing to add the surfactant in this way allows the surfactant to be effectively used to stabilize the aqueous dispersion. Presumably, toner with the particle size distribution being uniform can be obtained by aggregating such a stabilized aqueous dispersion, and as a result, electrophotographic toner is obtained, which has excellent heat-resistant storage stability, providing the excellent gloss of a printed material.

For mixing and dispersing the polyester resin, the organic solvent, the surfactant, and a neutralizer and water, chemical dispersion processes such as phase inversion emulsion and a mechanical dispersion processes such as a homogenizer and an ultrasonic disperser can be used.

### (Step 1)

The step 1 in the present invention is of mixing together at least a polyester resin, an organic solvent, and a neutralizer to obtain a mixture. The polyester resin, the organic solvent, and the neutralizer used in the step 1 are as described above.

The content of the polyester resin in the dispersion obtained in the step 1 is preferably from 35 to 98 weight %, more preferably from 40 to 95 weight %, further preferably from 40 to 90 weight %, furthermore preferably from 50 to 90 weight %, furthermore preferably from 70 to 90 weight %, from the viewpoint of the dispersion stability of the polyester resin.

The amount used of the organic solvent is preferably from 3 to 500 parts by weight, more preferably from 5 to 150 parts by weight, further preferably from 5 to 100 parts by weight, furthermore preferably from 10 to 80 parts by weight, furthermore preferably from 10 to 60 parts by weight, furthermore preferably from 10 to 40 parts by weight, based on 100 parts by weight of the polyester resin from the view point of the heat-resistant storage stability of toner and the gloss of a printed material.

Regarding the amount used of the organic solvent, the weight ratio of the polyester resin and the organic solvent (polyester resin/organic solvent) is preferably from 1/5 to 1/0.03, more preferably from 1/1.5 to 1/0.05, further preferably from 1/1 to 1/0.05, furthermore preferably from 1/0.8 to 1/0.1, furthermore preferably from 1/0.6 to 1/0.1, furthermore preferably from 1/0.4 to 1/0.1, from the viewpoint of the heat-resistant storage stability of toner and the gloss of a printed material.

Regarding the amount used of the neutralizer, the degree of neutralization of the polyester resin with the neutralizer preferably falls within the above-mentioned range.

In the step 1, the addition sequence of each raw material is not limited but the polyester resin preferably is mixed with the organic solvent and then with the neutralizer.

The mixing is preferably conducted with a generally used mixing stirrer such as an anchor type, an external rotation stirrer, or the like.

The temperature during mixing in the step 1 is preferably from 5 to 50° C., more preferably from 10 to 40° C., further preferably from 20 to 35° C., from the viewpoint of stabilizing the process temperature, shortening the process time, decreasing the viscosity of a solution, and the like. The stirring is preferably conducted until noticeable phase separation, the existence of insolubles, or the like is not seen. The stirring time depends on the stirring rate and the temperature condition but is preferably from 0.5 to 5 hours, more preferably from 1 to 3 hours.

In the step 1 in the present invention, any components may further added without influencing the effect of the invention. For example, the components to be further added include inorganic salts, organic solvents other than the above-mentioned ones, and surfactants with a concentration equal to or less than that limited in the present invention.

### (Step 2)

The step 2 in the present invention is of mixing the mixture obtained in the step 1 with at least water, optionally a surfactant to obtain a resin dispersion.

Regarding the amount used of water in the step 2, the weight ratio of water and the organic solvent (water/organic solvent) is preferably from 70/30 to 98/2, more preferably from 80/20 to 95/5, further preferably from 85/15 to 95/5, furthermore preferably from 88/12 to 95/5, from the viewpoint of the heat-resistant storage stability of toner and the gloss of a printed material.

Regarding the amount used of water in the step 2, the weight ratio of water and the polyester resin (water/polyester resin) is preferably from 20/80 to 90/10, more preferably from 30/70 to 85/15, further preferably from 50/50 to 85/15, furthermore preferably from 60/40 to 75/25, from the viewpoint of the heat-resistant storage stability of toner and the gloss of a printed material.

The mixing is preferably conducted with a generally used mixing stirrer such as an anchor type, an external rotation stirrer, or the like.

When a mixing stirrer such as an anchor type, the circumferential speed of stirring is preferably from 200 to 20 m/minute, more preferably from 150 to 40 m/minute, further preferably from 100 to 60 m/minute, from the viewpoint of the dispersibility.

The temperature during mixing in the step 2 is preferably from 5 to 50° C., more preferably from 10 to 40° C., and further preferably from 20 to 35° C., from the viewpoint of stabilizing the process temperature, shortening the process time, decreasing the viscosity of a solution, and the like.

In the step 2, the way to add and mix water and the surfactant are not limited in particular. The total amount of water and the surfactant may be added at one time in the mixture obtained in the step 1. Alternatively, water and the surfactant may be added in several batches, may be intermittently added dropwise, may be continuously added through a pump, or the like.

The surfactant is added together with or after water. From the viewpoint of the dispersibility of the mixture obtained in the step 1, a surfactant aqueous solution in which the surfactant is previously dissolved in water is preferably added intermittently or continuously. The addition time depends on the stirring rate and the temperature condition but is preferably from 0.5 to 5 hours, more preferably from 1 to 3 hours, from the viewpoint of the dispersibility of the mixture obtained in the step 1.

### (Step 3)

The step 3 in the present invention is of removing the organic solvent from the resin dispersion obtained in the step 2 to obtain an aqueous dispersion of a polyester resin (binder resin).

The way to remove the organic solvent in the step 3 is not limited in particular so that the organic solvent can be removed in any different ways. However, the resin dispersion is preferably distilled because the organic solvent dissolves in water. Alternatively, the organic solvent may not be completely removed to remain in the aqueous dispersion. In this case, the amount of the remaining organic solvent is preferably 1 weight % or less, more preferably 0.5 weight % or less, further preferably substantially 0%, in the aqueous dispersion.

When the organic solvent is removed by distillation, the resin dispersion is preferably heated to evaporate the organic solvent at a temperature equal to or more than the boiling point of the organic solvent to be used, with being stirred. Furthermore, from the viewpoint of maintaining the dispersion stability of the polyester resin, the resin dispersion is more preferably heated to evaporate the organic solvent at a temperature equal to or more than the boiling point of the organic solvent to be used under reduced pressure. The resin dispersion may be heated before or after the pressure is reduced. From the viewpoint of maintaining the dispersion stability of the polyester resin, the temperature and the pressure are preferably maintained to evaporate the organic solvent.

### (Step 4)

The step 4 in the present invention is of mixing the aqueous dispersion obtained in the step 3 with a surfactant optionally.

The amount of the surfactant added in the step 4 is preferably from 50 to 100 weight %, more preferably from 60 to 100 weight %, further preferably from 70 to 100 weight %, based on the total amount of the surfactant added in the steps 1 to 4 from the viewpoint of the heat-resistant storage stability of toner and the gloss of a printed material.

The amount of the surfactant added in the step 4 is preferably from 50 to 100 weight %, more preferably from 60 to 100 weight %, further preferably from 70 to 100 weight %, furthermore preferably from 80 to 100 weight %, based on the total amount of the surfactant added in the steps 2 and 4 from the viewpoint of the heat-resistant storage stability of toner and the gloss of a printed material.

The surfactant is preferably added with being stirred using a generally used mixing stirrer such as an anchor type blade, an external rotation stirrer, or the like.

When a mixing stirrer such as an anchor type, the circumferential speed of stirring is preferably from 200 to 20 m/minute, more preferably from 150 to 40 m/minute, further preferably from 100 to 60 m/minute, from the viewpoint of the dispersibility.

The temperature during the addition of the surfactant in the step 4 is preferably from 5 to 50° C., more preferably from 10 to 40° C., and further preferably from 20 to 35° C., from the viewpoint of the dispersibility of the surfactant in water and the like.

The solid content concentration of the aqueous dispersion obtained through the process of producing the aqueous dispersion including the steps 1 to 4 is adjusted to preferably from 3 to 40 weight %, more preferably from 5 to 30 weight %, further preferably from 15 to 25 weight %, by appropriately adding water from the viewpoint of the stability and the handleability of the dispersing element. The solid content means the total amount of non-volatile components in the resin, the surfactant, and the like.

From the viewpoint of the particle size distribution and the heat-resistant storage stability of toner and the gloss of a printed material, the pH of the aqueous dispersion is preferably adjusted to 3 or less, preferably from 1 to 3, more preferably from 1.5 to 2.5 after the step 3 or 4, preferably the step 4.

To adjust the pH of the aqueous dispersion to 3 or less, an acid is preferably added. The acid is preferably an inorganic acid, more preferably hydrochloric acid from the viewpoint of efficiently decreasing the pH.

Subsequently, the pH of the aqueous dispersion is adjusted to 4 or more, preferably from 4 to 6, more preferably from 4.5 to 5.5.

To adjust the pH of the aqueous dispersion to 4 or more, a base is preferably added. The base is preferably an alkali metal hydroxide, more preferably sodium hydroxide from the viewpoint of efficiently increasing the pH.

### <Aggregation Step>

In the aggregation step, particles of the polyester resin (binder resin) in the aqueous dispersion are aggregated to obtain an aggregate particle dispersion.

In the aggregation step, an aggregating agent is preferably added in order to efficiently aggregate the particles. As the aggregating agent, organic aggregating agents such as cationic surfactants of quaternary salts and polyethyleneimine; and inorganic aggregating agents such as inorganic metal salts and inorganic ammonium salts are used.

From the viewpoint of the particle size distribution and the heat-resistant storage stability of toner and the gloss of a printed material, the aggregating agent is preferably an inorganic one, particularly an inorganic metal salt.

The inorganic metal salt includes, for example, sodium sulfate, sodium chloride, calcium chloride, calcium nitrate, barium chloride, magnesium chloride, zinc chloride, and aluminium chloride. The valence of the central metal of the inorganic metal salt is preferably 2 or more from the viewpoint of the particle size distribution and the heat-resistant storage stability of toner and the gloss of a printed material.

When the aggregating agent is added, the additive amount is preferably from 0.001 to 10 parts by weight, more preferably from 0.005 to 7 parts by weight, further preferably from 0.005 to 5 parts by weight, furthermore preferably from 0.01 to 1 part by weight, based on 100 parts by weight of the polyester resin from the viewpoint of the heat-resistant storage stability of toner and the gloss of a printed material.

The aggregating agent is preferably dissolved in an aqueous medium and then added. The mixture is preferably stirred sufficiently when and after the aggregating agent is added. In the aggregation step, the solid content concentration of the aqueous system is preferably from 5 to 50 weight %, more preferably from 5 to 40 weight %, further preferably from 5 to 30 weight %, in order to cause uniform aggregation.

In the aggregation step, from the viewpoint of uniformly dispersing the aggregating agent to causing uniform aggregation, the aggregating agent is preferably added at a temperature of from 20 to 40° C. and then preferably maintained at a temperature of from 40 to 60° C. until the particles have a predetermined particle size.

In the aggregation step, aggregation may be conducted after an additive including a colorant, a charge-controlling agent, a releasing agent, a conductive modifier, a reinforcing filler such as a fibrous material, an antioxidant, and an anti-aging agent is added. The additive can be used after dispersed in an aqueous solution.

The colorant is not limited in particular, including well-known colorants, which can be appropriately selected for any purpose. Specifically, the colorant includes various pigments such as Carbon black, inorganic composite oxide, Chrome Yellow, Hansa Yellow, Benzidine Yellow, Threne Yellow, Quinoline Yellow, Permanent Orange GTR, Pyrazolone Orange, Vulcan Orange, Watch Young Red, Permanent Red, and Brilliant Carmines 3B and 6B, Dupont Oil Red, Pyrazolone Red, Lithol Red, Rhodamine B Lake, Lake Red C, Bengal, Aniline Blue, Ultramarine Blue, Calco Oil Blue, Methylene Blue Chloride, Phthalocyanine Blue, Phthalocyanine Green, and Malachite Green Oxalate; and various dyes such as acridine dyes, xanthene dyes, azo dyes, benzoquinone dyes, azine dyes, anthraquinone dyes, indigo dyes, thioindigo dyes, phthalocyanine dyes, Aniline Black dyes, polymethine dyes, triphenylmethane dyes, diphenylmethane dyes, thiazine dyes, and thiazole dyes. These colorants may be used alone or in combination of any two or more. The additive amount of colorant is preferably from 0.1 to 20 parts by weight, more preferably from 1 to 10 parts by weight, based on 100 parts by weight of the polyester resin from the viewpoint of improving the image quality.

The charge-controlling agent includes chromium-azo dyes, iron-azo dyes, aluminum-azo dyes, and salicylic acid metal complexes. The various charge-controlling agents may be used alone or in combination of any two or more. When a charge-controlling agent is added, the additive amount is preferably from 0.1 to 8 parts by weight, more preferably from 0.3 to 7 parts by weight, based on 100 parts by weight of the polyester resin from the viewpoint of improving the image quality.

The releasing agent includes fatty acid amides such as oleic acid amide, erucic acid amide, ricinoleic acid amide, and stearic acid amide; plant waxes such as carnauba wax, rice wax, candelilla wax, wood wax, and jojoba oil; animal waxes such as bees wax; waxes including mineral waxes and petroleum waxes such as montan wax, ozokerite, ceresin, microcrystalline wax, and Fischer-Tropsch wax; polyolefin wax, paraffin wax, and silicones. The releasing agent may be used alone or in combination of any two or more. The melting point of the releasing agent is preferably from 60 to 140° C., more preferably from 60 to 100° C., from the viewpoint of the low-temperature fusing properties and the heat-resistant storage stability of toner and the gloss of a printed material.

When a releasing agent is added, the additive amount is preferably from 1 to 20 parts by weight, more preferably from 2 to 10 parts by weight, further preferably from 2.5 to 8 parts by weight, furthermore preferably from 3 to 5 parts by weight, in the toner from the viewpoint of the low-temperature fusing properties and the heat-resistant storage stability of toner and the gloss of a printed material.

The additive such as a colorant and a charge-controlling agent may previously be mixed with the polyester resin during the preparation of the resin particles. A dispersion in which each additive is dispersed in a dispersion medium such as water may be prepared separately, mixed with the aqueous dispersion of the polyester resin, and then subjected to the aggregation step.

To previously mix the additive with the polyester resin during the preparation of the resin particles, the polyester resin is preferably melt-mixed with the additive in advance.

For the melt-mixing, an open-roll type of two-axis kneading machine is preferably used. The open-roll type of two-axis kneading machine is provided with two rolls being close to each other in parallel, which can have heating function or cooling function by passing a heat medium through each of the two rolls. Therefore, the open-roll type of two-axis kneading machine has an open part to conduct melt-mixing as well as a heating roller and a cooling roller so that the heat of kneading generated during melt-mixing can be easily released in contrast to a general two-axis kneading machine.

The aqueous dispersion of each additive is obtained by mixing together each additive, a surfactant, and water and then by dispersing this mixture with a disperser.

### <Coalescence Step>

In the coalescence step, an aggregation terminator is added in the aqueous dispersion of the aggregate particles obtained in the aggregation step optionally, and then the aqueous dispersion is heated optionally to obtain coalesced particles.

The temperature of the dispersion in the coalescence step is a softening point of the polyester resin (binder resin) of preferably from −40 to +10° C., more preferably from −35 to +10° C., further preferably from −25 to +10° C., from the viewpoint of the particle size, the particle size distribution, the shape regulation of an intended toner and the fusion-bondability of particles and from the viewpoint of improving the heat-resistant storage stability of toner and the gloss of a printed material. Specifically, the temperature is preferably from 70 to 100° C., more preferably from 70 to 90° C. The stirring rate is preferably a rate not to precipitate aggregate particles.

When an aggregation terminator is used, preferably a surfactant, more preferably an anionic surfactant is used as the aggregation terminator. Among anionic surfactants, preferably at least one selected from the group consisting of an alkyl ether sulfate, an alkyl sulfate, and a linear alkylbenzenesulfonate, more preferably an alkyl ether sulfate is used.

### (Electrophotographic Toner)

The coalesced particles obtained in the coalescence step are appropriately subjected to a solid-liquid separation process such as filtration, a washing process and a drying process so that electrophotographic toner (sometimes simply referred to as “toner”) can be obtained.

In the washing process, for the purpose of ensuring the sufficient tribocharging properties and the sufficient reliability as toner, acids are preferably used to remove metal ions from the surface of the toner. The added nonionic surfactant is also removed completely by washing, preferably with an aqueous solution at a temperature equal to or less than the cloud point of the nonionic surfactant. The washing is preferably carried out several times.

In the drying process, any different ways such as vibration-induced fluidization drying, spray-drying, freeze-drying, and flash jetting can be employed. The water content of the toner is preferably adjusted to 1.5 weight % or less and more preferably 1.0 weight % or less from the viewpoint of the tribocharging properties.

As the electrophotographic toner obtained by the method of the present invention, the toner particles can be directly used. However, the electrophotographic toner, in which the surfaces of the toner particles are preferably treated by the addition of an auxiliary agent (external additive) such as a fluidizing agent, are preferably used. The external additive includes any fine particles including inorganic fine particles such as hydrophobic silica fine particles, titanium oxide fine particles, alumina fine particles, cerium oxide fine particles, and carbon black; and polymer fine particles of polycarbonate, polymethyl methacrylate and silicone resins. Among these, hydrophobic silica fine particles are preferable.

When the surfaces of the toner particles are treated with an external additive, the additive amount of the external additive is preferably from 1 to 5 parts by weight, more preferably from 1 to 3.5 parts by weight, and further preferably from 1 to 3 parts by weight, based on 100 parts by weight of the toner particles.

The volume-median particle size (D₅₀) of the toner is preferably from 1 to 10 μm, more preferably from 2 to 8 μm, further preferably from 3 to 7 μm, and furthermore preferably from 4 to 6 μm, from the viewpoint of increasing the image quality and the productivity.

The CV value of the toner is preferably 45% or less, more preferably 40% or less, further preferably 35% or less, and furthermore preferably 30% or less, furthermore preferably 25% or less, from the viewpoint of increasing the image quality and the productivity. The CV value can be calculated by the following expression: CV Value (%)=(Standard Deviation of Particle Size Distribution)/(Volume Median Particle Size (D₅₀))×100.

The electrophotographic toner obtained by the method of the present invention can be used as a one-component developer, or can be mixed with a carrier to be used as a two-component developer.

According to the present invention, the particle size distribution of toner can be uniformly controlled, and the obtained electrophotographic toner has excellent heat-resistant storage stability, providing the excellent gloss of a printed material.

The electrophotographic toner obtained by the method of the present invention can be suitably used as toner for electrophotography, which is employed in electrophotography, an electrostatic recording method, an electrostatic printing process, and the like, because the obtained electrophotographic toner has excellent heat-resistant storage stability, providing the excellent gloss of a printed material.

### EXAMPLES

### Measurement of Physical Properties of Resin

### (Softening Point of Resin)

Using a flow tester (trade name: “CFT-500D” available from Shimadzu Corporation), 1 g of a sample was subjected to a load of 1.96 MPa by a plunger while heated at a temperature increasing rate of 6° C./min, so as to be extruded through a nozzle with a diameter of 1 mm and a length of 1 mm. The decent amount of the plunger of the flow tester was plotted relative to the temperature, and then the softening point was determined as the temperature at which a half amount of the sample was flowed out.

### (Acid Value of Resin)

The acid value of the resin was measured based on the method of JIS K 0070, except that only the measuring solvent was changed from a mixture solvent of ethanol and ether specified in JIS K 0070 to a mixture solvent of acetone and toluene (acetone:toluene=1:1(volume ratio)).

<Measurement of Physical Properties of Resin Dispersion>(Volume median particle sizes (D₅₀) of resin particles in each dispersion, colorant fine particles, releasing agent fine particles, charge-controlling agent fine particles, and aggregate particles)

Using a laser diffraction particle size analyzer (trade name: “LA-920” available from HORIBA, Ltd.), distilled water was added in a cell for the measurement, and then the volume median particle sizes (D₅₀) were measured at a concentration at which the absorbance fells within an adequate range.

### (Volume Median Particle Size (D₅₀) and Dispersity (CV) of Toner)

Measuring instrument: “Coulter Multisizer II” available from Beckman Coulter Inc.

Aperture diameter: 100 μm

Analyzing software: “Coulter Multisizer AcuComp Version 1.19” available from Beckman Coulter Inc.

Electrolyte solution: “Isotone II” available from Beckman Coulter Inc.

Dispersion: EMULGEN 109P (polyoxyethylene lauryl ether available from Kao Corporation, HLB: 13.6) was dissolved in the above electrolyte solution to prepare a dispersion with a concentration of 5 weight %.

Dispersing condition: 10 mg of a measurement sample was added to 5 mL of the dispersing solution, and dispersed using an ultrasonic disperser for 1 minute. Then, 25 mL of the electrolyte solution was added to this dispersion and further dispersed using the ultrasonic disperser for 1 minute to prepare a sample dispersion.

Measurement condition: The sample dispersion was added to 100 mL of the electrolyte solution to adjust the concentration of the sample dispersion so that the particle sizes of 30,000 particles can be measured within 20 seconds. Subsequently, the particle sizes of 30,000 particles were measured, and then the volume median particle size (D₅₀) was determined from the particle size distribution.

The CV (%) value was calculated by the following expression: CV Value (%)=(Standard Deviation of Particle Size Distribution)/(Volume Median Particle Size (D₅₀))×100.

### (Measurement of Solid Content of Resin Dispersion)

Using an infrared moisture meter (trade name: “FD-230” available from Kett Electric Laboratory), 5 g of the resin dispersion was dried at a temperature of 150° C. under the measurement mode 96 (monitoring time: 2.5 minute/variation range: 0.05%) to measure the water content (weight %) of the resin dispersion. The solid content concentration was calculated according to the following expression:

Solid content concentration (weight %)=100−M

wherein M: Water content (weight %) of resin dispersion={(W−W₀)/W}×100
W: Sample weight before measurement (initial sample weight)
W₀: Sample weight after measurement (absolute dry weight).

### (pH of Emulsion)

Using a pH meter (trade name: “HM-20P” available from DKK-TOA CORPORATION), the pH of the emulsion was measured at 20° C.

### <Evaluation of Toner>

### (Heat-Resistant Storage Stability of Toner)

4 g of the toner was added in a 30-mL container (with a diameter of about 3 cm) and left under an environment of a temperature of 55° C. and a humidity of 70% for 48 hours. Subsequently, the aggregation degree of the toner was observed to visually evaluate the storage stability according to the following criterion. The evaluation score C or higher is preferable.

A: Aggregation is not observed after 48 hours at all.
B: Aggregation is not be observed after 36 hours but slightly observed after 48 hours.
C: Aggregation is not be observed after 24 hours but clearly observed after 36 hours.
D: Aggregation is observed within 24 hours.

### (Gloss of Printed Material)

The toner was mounted in a copy machine (trade name: “AR-505” available from SHARP CORPORATION), in which the fuser was modified to fuse toner outside, and then a printed material with unfused toner images was obtained (print area: 2 cm×12 cm, deposit amount: 0.5 mg/cm²). Subsequently, with the modified fuser, the toner was fused under the condition of a temperature of 160° C. and a paper feed speed of 400 mm/sec. As the print medium, J paper (trade name; available from Fuji Xerox Co., Ltd.) was used.

A piece of thick paper was laid under the image. Using the gloss checker (trade name: “IG-330” available from HORIBA, Ltd.), the gloss of the printed material was measured at an incidence angle of 65°. The higher the obtained value is, the higher the gloss is. The evaluation score 20 or higher is preferable.

### <Production of Polyester Resin (Binder Resin)>

### Production Example 1

### Binder Resin A

The raw material monomers of the polyester except trimellitic anhydride, the pyrogallol compound, and the esterification catalyst as shown in Table 1 were added in a 10-L four-necked flask equipped with a thermometer, a stainless steel stirrer, a flowing condenser, and a nitrogen inlet and then heated to a temperature of 180° C. then 235° C. for 10 hours in a mantle heater in a nitrogen atmosphere. Subsequently, the reaction rate being reached 95% or more at a temperature of 235° C. was confirmed. Then, the reactant was cooled to a temperature of 160° C. In the mixture, the mixed solution of the raw material monomers of the vinyl resin, the double-reactive monomer, and the polymerization initiator as shown in Table 1 were added dropwise for 1 hour. Then, the reactant was maintained at a temperature of 160° C. for 30 minutes, heated to a temperature of 200° C., and reacted under a reduced pressure of 8 kPa for one hour. In the reactant, trimellitic anhydride was added. The reactant was heated to a temperature of 210° C. and then reacted until the softening point reaches a temperature of 99° C. to obtain the binder resin A.

### Production Example 2

### Binder Resin B

The raw material monomers, 4-t-butylcatechol, the pyrogallol compound, and the esterification catalyst as shown in Table 1 were added in a 10-L four-necked flask equipped with a thermometer, a stainless steel stirrer, a flowing condenser, and a nitrogen inlet and heated to a temperature of 180° C. then 210° C. for 5 hours in a mantle heater in a nitrogen atmosphere. Then, the reactant was reacted until the softening point reaches a temperature of 100° C. to obtain the binder resin B.

TABLE 1

| | | | Production | | Production | |
|---|---|---|---|---|---|---|
| | | | Example 1 | | Example 2 | |
| | | | Binder resin | | | |
| | | | A | | B | |
| | | | g | mol % *3 | g | mol % *3 |
| Raw material monomer | Alcohol | BPA-PO (*1) | 4204 | 70 | 5947 | 100 |
| of polyester resin | component | BPA-EO (*2) | 1673 | 30 | — | — |
| | Acid | Fumaric acid | — | — | 2053 | 104 |
| | component | Terephthalic | 1595 | 56 | — | — |
| | | acid | | | | |
| | | Trimellitic | 428 | 13 | — | — |
| | | anhydride | | | | |

| | | | | | |
|---|---|---|---|---|---|
| Raw material monomer | Styrene | 1480 | — | — | — |
| of vinyl resin | 2-ethylhexyl acrylate | 325 | — | — | — |
| Double-reactive | Acrylic acid | 99 | 8 | — | — |
| monomer | | | | | |

| | | | |
|---|---|---|---|
| Esterification catalyst | di(2-ethylhexanoic | 40 | 40 |
| | acid)tin(II) (g) | | |
| Pyrogallol compound | Gallic acid | 1.6 | 1.6 |
| Radical polymerization | Dibutyl peroxide (g) | 72 | — |
| initiator | | | |
| Radical polymerization | 4-t-butylcatechol (g) | — | 4 |
| inhibitor | | | |
| Physical properties | Softening point (° C.) | 99 | 100 |
| | Acid value (mgKOH/g) | 22 | 19 |

(*1): BPA-PO: Polyoxypropylene (2.2) adduct of bisphenol A
(*2): BPA-EO: Polyoxyethylene (2.2) adduct of bisphenol A
*3: mol %: Mole ratio based on 100 (mol) of all alcohol components

### Preparation of Dispersion Other than Resin Dispersion

### Preparation of Colorant Dispersion

50 g of copper phthalocyanine (trade name: “ECB-301” available from Dainichiseika Color & Chemicals Mfg. Co., Ltd.), 5 g of a nonionic surfactant (trade name: “EMULGEN 150” available from Kao Corporation), and 200 g of ion-exchanged water were mixed together. The mixture was dispersed with a homogenizer for 10 minutes to obtain a colorant dispersion containing colorant fine particles. The volume median particle size (D₅₀) was 130 nm.

(Preparation of Releasing Agent Dispersion) 50 g of paraffin wax (trade name: “HNP9” available from NIPPON SEIRO Co., Ltd.; melting point: 85° C.), 5 g of a cationic surfactant (trade name: “SANISOL B50” available from Kao Corporation), and 200 g of ion-exchanged water were heated to a temperature of 95° C. The paraffin wax was dispersed with a homogenizer. Subsequently, the mixture dispersion was dispersed with a pressure pump homogenizer to obtain a releasing agent dispersion containing releasing agent fine particles. The volume median particle size (D₅₀) was 450 nm.

### (Preparation of Charge-Controlling Agent Dispersion)

50 g of a charge-controlling agent (trade name: “BONTRON E-84” available from ORIENT CHEMICAL INDUSTRIES Co., Ltd.), 5 g of a nonionic surfactant (trade name: “EMULGEN 150” available from Kao Corporation), and 200 g of ion-exchanged water were mixed together. Using glass beads, the mixture was dispersed with a sand grinder for 10 minutes to obtain a charge-controlling agent dispersion containing charge-controlling agent fine particles. The volume median particle size (D₅₀) of the charge-controlling agent was 400 nm.

### Example 1

### Production of Aqueous Dispersion of Binder Resin

In a 3-L container with a stirrer, a reflux condenser, a dropping funnel, a thermometer, and a nitrogen inlet, 20 g of ethyl acetate and 100 g of the binder resin A were added and then dissolved at a temperature of 30° C. for 2 hours. In the obtained solution, 20% of an ammonia aqueous solution was added to adjust the degree of neutralization to be 60 mol %. The mixture solution was stirred for 30 minutes (Step 1). While being stirred at 250 r/minute (circumferential speed: 80 m/minute), 200 g of ion-exchanged water was mixed with 0.9 g of the solid content of an anionic surfactant (sodium dodecylbenzenesulfonate, trade name: “NEOPELEX G-15” available from Kao Corporation). The mixture was added in the mixture solution obtained in the step 1 for 70 minutes (Step 2). Subsequently, this dispersion was heated to a temperature of 50° C. for 30 minutes, and then ethyl acetate was evaporated under a reduced pressure (Step 3). The dispersion was cooled to a temperature of 20° C., and then the solid content concentration was measured and adjusted to be 20 weight % by adding ion-exchanged water to obtain an aqueous dispersion. Subsequently, while being stirred at 250 r/minute (circumferential speed: 80 m/minute), the aqueous dispersion was heated to a temperature of 30° C. The aqueous dispersion was mixed with 2.1 g of the solid content of an anionic surfactant (sodium dodecylbenzenesulfonate, trade name: “NEOPELEX G-15” available from Kao Corporation). Then, the mixture dispersion was stirred for 30 minutes (Step 4). In the mixture dispersion, 1 normal of a hydrochloric acid aqueous solution was added dropwise to adjust the pH to be 2. The mixture dispersion was stirred for 1 hour. Subsequently, while being stirred at 250 r/minute (circumferential speed: 80 m/minute), 5 weight % of a sodium hydroxide aqueous solution was added dropwise in the mixture dispersion to adjust the pH to 5. Then, the mixture dispersion was stirred for 1 hour to obtain the binder resin dispersion A-1.

### (Production of Toner)

300 g of the binder resin dispersion obtained in the above-mentioned steps, 8 g of the colorant dispersion, 10 g of the releasing agent dispersion, 2 g of the charge-controlling agent dispersion, and 52 g of de-ionized water were added in a 2-L container. While the mixture was stirred at 100 r/minute (the circumferential speed: 31 m/minute) with a paddle agitator, 150 g of 0.2 weight % of calcium chloride aqueous solution was added dropwise in the mixture at a temperature of 20° C. for 30 minutes. The mixture solution was heated while being stirred and maintained at a temperature of 50° C. After 3 hours, the mean particle size reached 4.5 μm. Subsequently, as an aggregation terminator, a diluent in which 4.2 g of an anionic surfactant (trade name: “EMAL E-27C” available from Kao Corporation; solid content: 28 weight %) was diluted with 37 g of de-ionized water was added. The mixture solution was heated to and maintained at a temperature of 80° C. for 1 hour. Then, the heating was terminated. By this way, coalesced particles were formed in the mixture solution. Subsequently, the mixture solution was slowly cooled to a temperature of 20° C., filtered with a 150 micron sieve (mesh size: 150 μm), subjected to the suction filtration process, the washing process, and then the dry process to obtain toner particles.

### (External Addition Step)

Based on 100 parts by weight of the above-mentioned toner particles, 1.0 part by weight of a hydrophobic silica (trade name: “NAX-50” available from Nippon Aerosil Co., Ltd., number-average particle size: 40 nm), 0.6 parts by weight of a hydrophobic silica (trade name: “R972” available from Nippon Aerosil Co., Ltd.; number-average particle size: 16 nm), and 0.5 parts by weight of titanium oxide (trade name: “JMT-1501B” available from TAYCA CORPORATION; number-average particle size: 15 nm) were added in a 10-L Henschel mixer equipped with an ST blade and an A0 blade (available from Nippon Coke & Engineering Co., Ltd.) and stirred at 3,000 rpm for 2 minutes to obtain toner. Table 2 shows the evaluation results of this toner.

### Examples 2 to 8

Except that the amount of the surfactant added in each step of producing the aqueous dispersion of the binder resin of Example 1 was changed as described in Table 2, the binder resin dispersions A-2 to A-8 were produced in the same way as Example 1 to obtain toner respectively. Table 2 shows the evaluation results of the toners. The total amount of the surfactant added in the steps 1 to 4 was 3 parts by weight based on 100 parts by weight of the resin.

### Example 9

Except that the binder resin A was changed to the binder resin B, the binder resin dispersion B-1 was produced in the same way as Example 1 to obtain toner. Table 2 shows the evaluation results of the toner.

### Examples 10 and 11

Except that the type of the organic solvent was changed as shown in Table 2, the binder resin dispersions A-9 and A-10 were produced in the same way as Example 1 to obtain toner respectively. Table 2 shows the evaluation results of the toners.

### Example 12

After the step 4 of producing the aqueous dispersion of the binder resin of Example 1, 1 normal of a hydrochloric acid aqueous solution was added dropwise to adjust the pH to be 2, and then the aqueous dispersion A-11 was produced to obtain the toner. Table 2 shows the evaluation results of the toner.

### Example 13

After the step 4 of producing the aqueous dispersion of the binder resin of Example 1, the pH was not adjusted, and then the aqueous dispersion A-12 was produced to obtain the toner. Table 2 shows the evaluation results of the toner.

### Example 14

Except that 5 weight % of a sodium hydroxide aqueous solution instead of an ammonia aqueous solution was added as the neutralizer in the step 1 of producing the aqueous dispersion of the binder resin of the Example 1 to adjust the degree of neutralization to be 60 mol %, the binder resin dispersion A-13 was produced in the same way as Example 1 to obtain toner. Table 2 shows the evaluation results of the toner.

### Example 15

Except that triethylamine instead of an ammonia aqueous solution was added as the neutralizer in the step 1 of producing the aqueous dispersion of the binder resin of the Example 1, the binder resin dispersion A-14 was produced in the same way as Example 1 to obtain toner. Table 2 shows the evaluation results of the toner.

### Examples 16 to 22

Except that the amount of the organic solvent was changed to 5 g (Example 16), 10 g (Example 17), 50 g (Example 18), 60 g (Example 19), 70 g (Example 20), 80 g (Example 21), and 130 g (Example 22) and adjust the ratio of the binder resin to the organic solvent was as shown in Table 2, the binder resin dispersions A-15 to A-21 were produced in the same way as Example 1 to obtain toner respectively. Table 2 shows the evaluation results of the toners.

### Examples 23 to 27

Except that the amount of water was changed to 650 g (Example 23), 380 g (Example 24), 145 g (Example 25), and 100 g (Example 26), 60 g (Example 27) to adjust the ratio of water and the organic solvent was as shown in Table 2, the binder resin dispersions A-22 to A-26 were produced in the same way as Example 1 to obtain toner respectively. Table 2 shows the evaluation results of the toners.

### Examples 28 and 29

Except that 0.9 g (solid content) of the anionic surfactant in the step 2 of Example 1 was changed to EMULGEN E430 (trade name; polyoxyethylene oleyl ether, nonionic surfactant available from Kao Corporation) or 3.3 g (solid content) of EMAL E-27C (trade name; sodium polyoxyethylene laurylether sulphate, anionic surfactant available from Kao Corporation) and except that 2.1 g of the anionic surfactant in the step 4 of Example 1 was changed to 2.1 g (solid content) of EMULGEN E430 or 7.8 g (solid content) of EMAL E-27C, the binder resin dispersions A-27 and A-28 were produced in the same way as Example 1 to obtain toner respectively. Table 2 shows the evaluation results of the toners.

### Comparative Examples 1 and 2

Except that the amount of the surfactant added in each step of producing the aqueous dispersion of the binder resin of the Example 1 was changed as described in Table 2, the binder resin dispersions A-29 and A-30 were produced in the same way as Example 1 to obtain toner respectively. Table 2 shows the evaluation results of the toners.

### Comparative Example 3

Except that the surfactant was not added in the step 1 of producing the aqueous dispersion of the binder resin of the Example 1, the binder resin dispersion A-31 was produced in the same way as Example 1 to obtain toner. Table 2 shows the evaluation result of the toner.

TABLE 2

| | Example | Example | Example | Example | Example | Example | Example | Example | Example |
|---|---|---|---|---|---|---|---|---|---|
| | 1 | 2 | 3 | 4 | 5 | 6 | 7 | 8 | 9 |
| Binder resin | A | A | A | A | A | A | A | A | B |
| Aqueous dispersion | A-1 | A-2 | A-3 | A-4 | A-5 | A-6 | A-7 | A-8 | B-1 |
| Amount of surfactant | 0 | 0 | 10 | 20 | 20 | 0 | 20 | 10 | 0 |
| added in step 1 (wt %) | | | | | | | | | |
| Amount of surfactant | 30 | 10 | 27 | 24 | 0 | 50 | 80 | 90 | 30 |
| added in step 2 (wt %) | | | | | | | | | |
| Amount of surfactant | 70 | 90 | 63 | 56 | 80 | 50 | 0 | 0 | 70 |
| added in step 4 (wt %) | | | | | | | | | |
| Binder resin/Organic | 1/0.2 | 1/0.2 | 1/0.2 | 1/0.2 | 1/0.2 | 1/0.2 | 1/0.2 | 1/0.2 | 1/0.2 |
| solvent | | | | | | | | | |
| Water/Organic solvent | 91/9 | 91/9 | 91/9 | 91/9 | 91/9 | 91/9 | 91/9 | 91/9 | 91/9 |
| Type of solvent | EtAc | EtAc | EtAc | EtAc | EtAc | EtAc | EtAc | EtAc | EtAc |
| Type of neutralizer | NH₃ | NH₃ | NH₃ | NH₃ | NH₃ | NH₃ | NH₃ | NH₃ | NH₃ |
| pKa of neutralizer | 9.3 | 9.3 | 9.3 | 9.3 | 9.3 | 9.3 | 9.3 | 9.3 | 9.3 |
| pH of aqueous | 5 | 5 | 5 | 5 | 5 | 5 | 5 | 5 | 5 |
| dispersion | | | | | | | | | |
| Volume median particle | 4.5 | 4.4 | 4.5 | 4.5 | 4.7 | 4.6 | 4.7 | 4.7 | 4.5 |
| size of toner D₅₀ (μm) | | | | | | | | | |
| CV value of toner (%) | 21 | 23 | 24 | 25 | 26 | 37 | 41 | 35 | 28 |
| Storage stability | A | A | B | B | B | B | B | B | B |
| Gloss | 43 | 41 | 38 | 36 | 38 | 26 | 23 | 24 | 34 |
| | Example | Example | Example | Example | Example | Example | Example | Example | Example |
| | 10 | 11 | 12 | 13 | 14 | 15 | 16 | 17 | 18 |
| Binder resin | A | A | A | A | A | A | A | A | A |
| Aqueous dispersion | A-9 | A-10 | A-11 | A-12 | A-13 | A-14 | A-15 | A-16 | A-17 |
| Amount of surfactant | 0 | 0 | 0 | 0 | 0 | 0 | 0 | 0 | 0 |
| added in step 1 (wt %) | | | | | | | | | |
| Amount of surfactant | 30 | 30 | 30 | 30 | 30 | 30 | 30 | 30 | 30 |
| added in step 2 (wt %) | | | | | | | | | |
| Amount of surfactant | 70 | 70 | 70 | 70 | 70 | 70 | 70 | 70 | 70 |
| added in step 4 (wt %) | | | | | | | | | |
| Binder resin/Organic | 1/0.2 | 1/0.2 | 1/0.2 | 1/0.2 | 1/0.2 | 1/0.2 | 1/0.05 | 1/0.1 | 1/0.5 |
| solvent | | | | | | | | | |
| Water/Organic solvent | 91/9 | 91/9 | 91/9 | 91/9 | 91/9 | 91/9 | 91/9 | 91/9 | 91/9 |
| Type of organic solvent | MEK | i-PrAc | EtAc | EtAc | EtAc | EtAc | EtAc | EtAc | EtAc |
| Type of neutralizer | NH₃ | NH₃ | NH₃ | NH₃ | NaOH | NEt₃ | NH₃ | NH₃ | NH₃ |
| pKa of neutralizer | 9.3 | 9.3 | 9.3 | 9.3 | 13 | 9.8 | 9.3 | 9.3 | 9.3 |
| pH of aqueous | 5 | 5 | 2 | 6 | 5 | 5 | 5 | 5 | 5 |
| dispersion | | | | | | | | | |
| Volume median particle | 4.3 | 4.5 | 4.4 | 4.6 | 4.3 | 4.2 | 4.7 | 4.9 | 4.6 |
| size of toner D₅₀ (μm) | | | | | | | | | |
| CV value of toner (%) | 31 | 22 | 27 | 28 | 31 | 24 | 32 | 26 | 25 |
| Storage stability | B | A | B | B | B | A | B | A | B |
| Gloss | 32 | 31 | 34 | 29 | 31 | 33 | 27 | 41 | 36 |
| | Example | Example | Example | Example | Example | Example | Example | Example | Example |
| | 19 | 20 | 21 | 22 | 23 | 24 | 25 | 26 | 27 |
| Binder resin | A | A | A | A | A | A | A | A | A |
| Aqueous dispersion | A-18 | A-19 | A-20 | A-21 | A-22 | A-23 | A-24 | A-25 | A-26 |
| Amount of surfactant | 0 | 0 | 0 | 0 | 0 | 0 | 0 | 0 | 0 |
| added in step 1 (wt %) | | | | | | | | | |
| Amount of surfactant | 30 | 30 | 30 | 30 | 30 | 30 | 30 | 30 | 30 |
| added in step 2 (wt %) | | | | | | | | | |
| Amount of surfactant | 70 | 70 | 70 | 70 | 70 | 70 | 70 | 70 | 70 |
| added in step 4 (wt %) | | | | | | | | | |
| Binder resin/Organic | 1/0.6 | 1/0.7 | 1/0.8 | 1/1.3 | 1/0.2 | 1/0.2 | 1/0.2 | 1/0.2 | 1/0.2 |
| solvent | | | | | | | | | |
| Water/Organic solvent | 91/9 | 91/9 | 91/9 | 91/9 | 97/3 | 95/5 | 88/12 | 83/17 | 75/25 |
| Type of organic solvent | EtAc | EtAc | EtAc | EtAc | EtAc | EtAc | EtAc | EtAc | EtAc |
| Type of neutralizer | NH₃ | NH₃ | NH₃ | NH₃ | NH₃ | NH₃ | NH₃ | NH₃ | NH₃ |
| pKa of neutralizer | 9.3 | 9.3 | 9.3 | 9.3 | 9.3 | 9.3 | 9.3 | 9.3 | 9.3 |
| pH of aqueous | 5 | 5 | 5 | 5 | 5 | 5 | 5 | 5 | 5 |
| dispersion | | | | | | | | | |
| Volume median particle | 5.0 | 5.1 | 4.8 | 4.5 | 4.5 | 4.8 | 4.6 | 4.6 | 4.4 |
| size of toner D₅₀ (μm) | | | | | | | | | |
| CV value of toner (%) | 24 | 31 | 30 | 35 | 30 | 23 | 22 | 24 | 28 |
| Storage stability | B | B | B | C | B | A | A | B | B |
| Gloss | 38 | 31 | 33 | 26 | 32 | 39 | 41 | 36 | 34 |

| | Example | Example |
|---|---|---|
| | 28 | 29 |
| Binder resin | A | A |
| Aqueous dispersion | A-27 | A-28 |
| Type of surfactant | E430 | E27C |
| Amount of surfactant | 0 | 0 |
| added in step 1 (wt %) | | |
| Amount of surfactant | 30 | 30 |
| added in step 2 (wt %) | | |
| Amount of surfactant | 70 | 70 |
| added in step 4 (wt %) | | |
| Binder resin/Solvent | 1/0.2 | 1/0.2 |
| Water/Organic solvent | 91/9 | 91/9 |
| Type of organic solvent | EtAc | EtAc |
| Type of neutralizer | NH₃ | NH₃ |
| pKa of neutralizer | 9.3 | 9.3 |
| pH of aqueous | 5 | 5 |
| dispersion | | |
| Volume median particle | 4.7 | 4.7 |
| size of toner D₅₀ (μm) | | |
| CV value of toner (%) | 25 | 22 |
| Storage stability | A | A |
| Gloss | 35 | 41 |

| | Comparative | Comparative | Comparative |
|---|---|---|---|
| | Example 1 | Example 2 | Example 3 |
| Binder resin | A | A | A |
| Aqueous dispersion | A-29 | A-30 | A-31 |
| Amount of surfactant | 40 | 40 | 0 |
| added in step 1 (wt %) | | | |
| Amount of surfactant | 60 | 0 | 30 |
| added in step 2 (wt %) | | | |
| Amount of surfactant | 0 | 60 | 70 |
| added in step 4 (wt %) | | | |
| Binder resin/Solvent | 1/0.2 | 1/0.2 | 1/0.2 |
| Water/Organic solvent | 91/9 | 91/9 | 91/9 |
| Type of organic solvent | EtAc | EtAc | EtAc |
| Type of neutralizer | NH₃ | NH₃ | — |
| pKa of neutralizer | 9.3 | 9.3 | — |
| pH of aqueous | 5 | 5 | — |
| dispersion | | | |
| Volume median particle | 4.5 | 4.7 | 4.8 |
| size of toner D₅₀ (μm) | | | |
| CV value of toner (%) | 59 | 49 | 86 |
| Storage stability | D | D | D |
| Gloss | 19 | 21 | 10 |

EtAc: Ethyl acetate
MEK: Methyl ethyl ketone
i-PrAc: Isopropyl acetate
NEt₃: Triethylamine
E430: EMULGEN E430 (trade name, available from Kao Corporation, nonionic surfactant)
E27C: EMAL E-27C (trade name, available from Kao Corporation, anionic surfactant)

From the above-mentioned results, it is found that according to the method of the present invention, the particle size distribution of toner can be uniformly controlled and that the obtained electrophotographic toner has excellent heat-resistant storage stability, providing the excellent gloss of a printed material.

1-18. (canceled)

19: A method of manufacturing an electrophotographic toner containing particles obtained by fusing aggregate particles obtained by aggregating an aqueous dispersion of a polyester resin for the toner, the method comprising:
(1) mixing together at least a polyester resin, an organic solvent, and a neutralizer to obtain a mixture;
(2) mixing the mixture obtained in (1) with at least water to obtain a resin dispersion;
(3) removing an organic solvent from the resin dispersion obtained in (2) to obtain the aqueous dispersion of the polyester resin; and
(4) optionally mixing the aqueous dispersion obtained in (3) with a surfactant,
wherein the aqueous dispersion of the polyester resin for the toner is obtained through (1) to (4), and the surfactant is added in a content of from 70 to 100 weight % based on the total amount of the surfactant added in at least one of (2) and (4).

20: The method according to claim 19, wherein the amount of the surfactant added in (4) is from 50 to 100 weight % based on the total amount of the surfactant added in (2) and (4).

21: The method according to claim 19, wherein the weight ratio of the polyester resin and the organic solvent (polyester resin/organic solvent) is from 1/5 to 1/0.03 in (1).

22: The method according to claim 19, wherein the weight ratio of water and the organic solvent (water/organic solvent) is from 70/30 to 98/2 in (2). 23 (New): The method according to claim 19, wherein the neutralizer in (1) has a pKa of 12 or less.

24: The method according to claim 19, further comprising adjusting the pH of the aqueous dispersion to 3 or less after (4).

25: The method of according to claim 24, wherein the adjusting the pH of the aqueous dispersion to 3 or less is performed by adding an inorganic acid to the aqueous dispersion.

26: The method according to claim 24, further comprising adjusting the pH of the aqueous dispersion to 4 or more, after the pH of the aqueous dispersion is adjusted to 3 or less after (4).

27: The method according to claim 19, wherein the organic solvent is acetate ester.

28: The method according to claim 19, wherein the polyester resin comprises a composite resin containing a polyester resin segment (a1) and a vinyl resin segment (a2).

29: The method according to claim 19, wherein the weight ratio of the polyester resin and the organic solvent (polyester resin/organic solvent) is from 1/0.6 to 1/0.1 in (1).

30: The method according to claim 19, wherein the weight ratio of water and the organic solvent (water/organic solvent) is from 88/12 to 95/5 in (2).

31: The method according to claim 19, wherein the surfactant is an anionic surfactant.

32: The method according to claim 19, wherein the neutralizer in (1) has a pKa of 8 or more.

33: The method according to claim 19, wherein the neutralizer is ammonia.

34: The method according to claim 19, wherein the degree of neutralization of the polyester resin with the neutralizer is from 20 to 100 mol %.

35: A method of manufacturing electrophotographic toner containing particles obtained by fusing aggregate particles obtained by aggregating an aqueous dispersion of a polyester resin for toner, the method comprising:
(1) mixing together at least a polyester resin, an organic solvent, and a neutralizer to obtain a mixture;
(2) mixing the mixture obtained in (1) with at least water to obtain a resin dispersion;
(3) removing an organic solvent from the resin dispersion obtained in (2) to obtain an aqueous dispersion of a polyester resin; and
(4) optionally mixing the aqueous dispersion obtained in (3) with a surfactant,
wherein the aqueous dispersion of the polyester resin for toner is obtained through the (1) to (4), the surfactant is added in a content of from 70 to 100 weight % based on the total amount of the surfactant added in at least one of (2) and (4), and the weight ratio of the polyester resin and the organic solvent (polyester resin/organic solvent) is from 1/0.6 to 1/0.1 in (1).

36: The method according to claim 28, wherein the polyester resin is a composite resin generated by addition polymerization in addition to the polycondensation of (i) raw material monomers of the vinyl resin and (ii) a double-reactive monomer reactive with both of the raw materials (i) and an alcohol component.

37: The method according to claim 25, further comprising adjusting the pH of the aqueous dispersion to 4 or more, after the pH of the aqueous dispersion is adjusted to 3 or less after (4).
